(19) United States
(12) Patent Application Publication
(10) Pub. No.: US 2004/0085760 A1
(43) Pub. Date: May 6, 2004

(54) Self-illuminating oil candle

(76) Inventor: Marsha P. Brizzie, Fountain Hills, AZ (US)

Correspondence Address: Marsha P. Brizzie, 10249 Demaret Dr., Fountain Hills, AZ, 85268, US

(21) Appl. No.: 10/287,902

(22) Filed: Nov. 6, 2002

(51) Int. Cl. F21L 19/00

(52) U.S. Cl. 362/161

(57) ABSTRACT

The invention provides an oil candle comprising a glass container which holds a decorative arrangement which is immersed in candle oil. The container is closed at its top by a transparent beveled glass closure which is provided with a center hole. A glass enclosed wick extends from above the glass enclosure (usually a disc) into the oil within the container. When the wick is lit, the flame brightly illuminates the decorative arrangement.

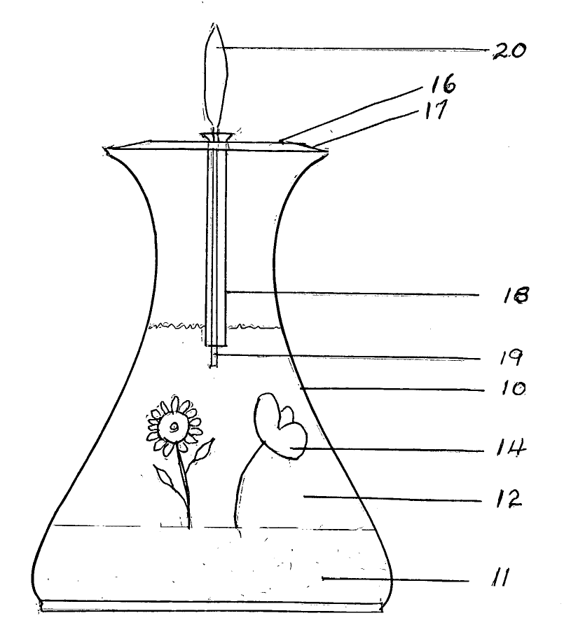

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention relates to oil candles of the kind in which a glass vessel containing decorative materials and candle fuel is topped with a closure through which a wick extends into the enclosed fuel.

In the past, decorative oil candles have employed bottles with a neck portion as the aforesaid glass container and the decorative contents have been dried or silk flowers or objects which could be passed through the bottle neck. For the most part, the bottle closure through which the wick passed was a porcelain plug.

In other instances, the wick was contained in a slender glass cylinder which had an enlarged head which prevented it from dropping through the bottle neck. Where the bottle opening was larger than the enlarged head, a grommet with an external diameter large enough to span the opening and an interior diameter less than that of the enlarged head was placed over the opening.

Such oil candles were valued for their attractive appearance and utility. Appreciation of the appearance depended, however, on an adequate external source of light to illuminate the contents, and this was absent in twilight or dark outdoors or in dim light indoors, thus, undermining or completely defeating the decorative effect for which the candle was created in the first place.

### BRIEF SUMMARY OF THE INVENTION

An object of this invention is to provide a decorative self-illuminating oil candle in which the appearance of the decorative material is brightly and visibly enhanced, and to a particularly pleasing and surprising extent in dim light, wherein the decorative effect of prior candles would go unnoticed.

I have found that the flame of the candle can be utilized to substantially illuminate the decorative contents of an oil candle by utilizing a transparent closure which extends without interruption from the wick or wick-holder where it passes through the closure to the margins of the glass container on which the closure is mounted. This allows sufficient light produced by the flame to pass into the interior of the container where, in combination with the magnifying effect of the oil, produces a surprisingly bright and enlarged image of the decorative contents.

### BRIEF DESCRIPTION OF THE DRAWING

The figure in the accompanying drawing is a view in elevation which illustrates a self-illuminating oil candle according to this invention.

### DETAILED DESCRIPTION OF THE INVENTION

A glass vase 10 contains a candle oil 12. Such oil is known commercially as “candle and lamp oil” and is available at hardware stores or general merchandise stores selling candles of various kind. The vase 10 contains decorative material 14 which may include silk, glass or dried flowers or a figurine. These are preferably supported by a particulate material 11 to hold them in place. The top of vase 10 is closed off by a glass disc 16 which is fastened by gluing to the upper margins of vase mouth. The disc may be provided with a beveled edge 17 which aids in guiding some light into the center of the vase. This disc is provided with a central hole through which the wick holder 18 extends. The wick holder encloses a wick 19 which acts to draw oil to the flame from the oil mass 12. A small part of the wick extends above the top edge of the wick holder and it is this part which, when ignited, creates the flame 20. The light from the flame passes through the wholly transparent disc 16 and brightly illuminates the decorative contents 14.

1. A self-illuminating oil candle comprising candle oil and decorative material within a glass container having a top opening covered by a transparent glass closure which has a wick extending through the closure down into the oil said closure being transparent throughout the area of the top opening which it covers.

2. Self-illuminating oil candle as described in claim 1 in which the transparent glass closure has a beveled edge which lies in part within the said top opening.
